(19) United States
(12) Patent Application Publication
(10) Pub. No.: US 2025/0364553 A1
(43) Pub. Date: Nov. 27, 2025

(54) SECONDARY BATTERY

(71) Applicant: MURATA MANUFACTURING CO., LTD., Kyoto (JP)

(72) Inventors: Yukihiro KATOU, Kyoto (JP); Akiko NAGAHARA, Kyoto (JP); Hideki NAKAI, Kyoto (JP)

(21) Appl. No.: 19/289,434

(22) Filed: Aug. 4, 2025

Related U.S. Application Data
(63) Continuation of application No. PCT/JP2024/012482, filed on Mar. 27, 2024.

(30) Foreign Application Priority Data
Mar. 29, 2023 (JP) 2023-054139

(51) Int. Cl. H01M 4/525; H01M 4/02; H01M 4/131; H01M 10/0525

(52) U.S. Cl. CPC H01M 4/525; H01M 4/131; H01M 10/0525; H01M 2004/028

(57) ABSTRACT

A secondary battery is provided and includes a positive electrode, a negative electrode, and an electrolytic solution. The positive electrode includes a positive electrode active material layer. The positive electrode active material layer includes positive electrode active material particles. The positive electrode active material particles each include a center part and a covering part. The center part includes a lithium composite oxide. The covering part is provided on a surface of the center part. The lithium composite oxide has a layered rock-salt crystal structure, and includes lithium, nickel, and another element as constituent elements. Where a sum of a content of nickel in the lithium composite oxide and a content of the other element in the lithium composite oxide is taken as 100 parts by mole, the content of nickel is greater than or equal to 80 parts by mole and less than or equal to 100 parts by mole. Based on an analysis of the positive electrode active material layer in a depth direction by time-of-flight secondary ion mass spectrometry, a first negative secondary ion derived from NiO₂⁻ and a second negative secondary ion derived from LiBO₂F⁻ are detectable, and a first depth profile and a second depth profile are acquirable.

### CROSS REFERENCE TO RELATED APPLICATIONS

The present application is a continuation of International Application No. PCT/JP2024/012482, filed on Mar. 27, 2024, which claims priority to Japanese Patent Application No. 2023-054139, filed on Mar. 29, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, a battery after being assembled is charged and discharged under heating to thereby allow a film component derived from an electrolytic solution (LiPF₆ and LiBF₄) to be present on a surface of a positive electrode, and the film component is analyzed by time-of-flight secondary ion mass spectrometry (TOF-SIMS).

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve an improved battery characteristic.

A secondary battery according to an embodiment of the present technology includes a positive electrode, a negative electrode, and an electrolytic solution. The positive electrode includes a positive electrode active material layer. The positive electrode active material layer includes positive electrode active material particles. The positive electrode active material particles each include a center part and a covering part. The center part includes a lithium composite oxide. The covering part is provided on a surface of the center part. The lithium composite oxide has a layered rock-salt crystal structure, and includes lithium, nickel, and another element as constituent elements. Where a sum of a content of nickel in the lithium composite oxide and a content of the other element in the lithium composite oxide is taken as 100 parts by mole, the content of nickel in the lithium composite oxide is greater than or equal to 80 parts by mole and less than or equal to 100 parts by mole. Based on an analysis of the positive electrode active material layer in a depth direction by time-of-flight secondary ion mass spectrometry, a first negative secondary ion derived from NiO₂⁻ and a second negative secondary ion derived from LiBO₂F⁻ are detectable, and a first depth profile and a second depth profile are acquirable. The first depth profile indicates a change in ionic strength of the first negative secondary ion in the depth direction. The second depth profile indicates a change in ionic strength of the second negative secondary ion in the depth direction. In the first depth profile, the ionic strength of the first negative secondary ion increases in the depth direction. In the second depth profile, the ionic strength of the second negative secondary ion decreases in the depth direction. The second depth profile includes a stepped region in which the ionic strength of the second negative secondary ion temporarily stops decreasing in the depth direction midway through an increase in the ionic strength of the first negative secondary ion in the depth direction.

### EFFECTS OF THE INVENTION

According to the secondary battery of an embodiment of the present technology, the positive electrode active material layer includes the positive electrode active material particles; the positive electrode active material particles each include the center part (the lithium composite oxide) and the covering part; the lithium composite oxide has the layered rock-salt crystal structure and includes lithium, nickel, and the other element as constituent elements; the content of nickel in the lithium composite oxide is greater than or equal to 80 parts by mole and less than or equal to 100 parts by mole; based on the analysis of the positive electrode active material layer in the depth direction by the time-of-flight secondary ion mass spectrometry, the first depth profile indicating the change in the ionic strength of the first negative secondary ion (NiO₂⁻) and the second depth profile indicating the change in the ionic strength of the second negative secondary ion (LiBO₂F⁻) are acquirable; in the first depth profile, the ionic strength of the first negative secondary ion increases in the depth direction; in the second depth profile, the ionic strength of the second negative secondary ion decreases in the depth direction; and the second depth profile includes the stepped region in which the ionic strength of the second negative secondary ion temporarily stops decreasing in the depth direction midway through the increase in the ionic strength of the first negative secondary ion in the depth direction. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a sectional diagram illustrating a configuration of a positive electrode active material particle.

FIG. 4 is a diagram illustrating a result of analysis of a positive electrode active material layer in a depth direction by time-of-flight secondary ion mass spectrometry.

FIG. 5 is a block diagram illustrating a configuration of an application example of the secondary battery.

FIG. 6 is a sectional diagram illustrating a configuration of a secondary battery for testing.

### DETAILED DESCRIPTION

The present technology is described below in further detail including with reference to the drawings according to an embodiment.

A description is given first of a secondary battery according to an embodiment of the present technology.

The secondary battery to be described here is a secondary battery in which a battery capacity is obtained through insertion and extraction of an electrode reactant, and includes a positive electrode, a negative electrode, and an electrolytic solution.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

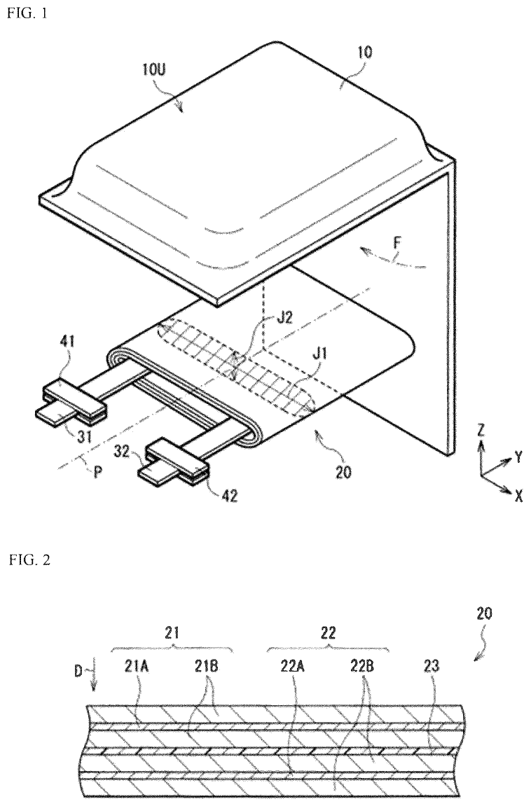

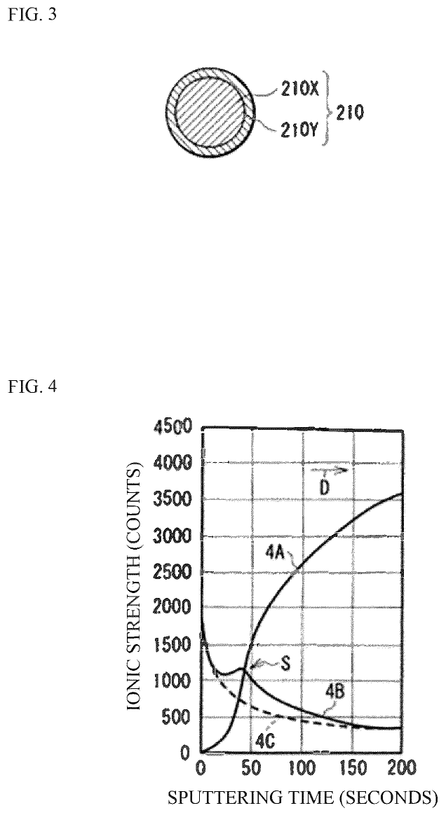

FIG. 1 illustrates a perspective configuration of the secondary battery. FIG. 2 illustrates a sectional configuration of a battery device 20 illustrated in FIG. 1. FIG. 3 illustrates a sectional configuration of a positive electrode active material particle 210.

Note that FIG. 1 illustrates a state where an outer package film 10 and the battery device 20 are separated from each other, and illustrates a section of the battery device 20 along an XZ plane by a dashed line. FIG. 2 illustrates only a part of the battery device 20.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 having flexibility or softness as an outer package member to contain the battery device 20 inside, as described above. The secondary battery illustrated in FIG. 1 is thus a secondary battery of what is called a laminated-film type.

As illustrated in FIG. 1, the outer package film 10 has a pouch-shaped structure that is sealed in a state where the battery device 20 is contained inside the outer package film 10. The outer package film 10 thus contains a positive electrode 21, a negative electrode 22, and a separator 23 that are to be described later.

Here, the outer package film 10 is a single film-shaped member and is folded toward a folding direction F. The outer package film 10 has a depression part 10U in which the battery device 20 is to be placed. The depression part 10U is what is called a deep drawn part.

Specifically, the outer package film 10 is a three-layered laminated film including a fusion-bonding layer, a metal layer, and a surface protective layer that are stacked in this order from an inner side. In a state where the outer package film 10 is folded, outer edge parts of the fusion-bonding layer that are opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained inside the outer package film 10. The battery device 20 is what is called a power generation device, and includes, as illustrated in FIGS. 1 and 2, the positive electrode 21, the negative electrode 22, and the separator 23.

Here, the battery device 20 is what is called a wound electrode body. Accordingly, the positive electrode 21 and the negative electrode 22 are wound about a winding axis P, being opposed to each other with the separator 23 interposed therebetween. The winding axis P is a virtual axis extending in a Y-axis direction.

A three-dimensional shape of the battery device 20 is not particularly limited. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials into which lithium is to be inserted and from which lithium is to be extracted. Note that the positive electrode active material layer 21B may further include any one or more of other materials including, without limitation, a positive electrode binder and a positive electrode conductor. A method of forming the positive electrode active material layer 21B is not particularly limited, and specifically includes a method such as a coating method.

Here, the positive electrode active material layer 21B is provided on each of the two opposed surfaces of the positive electrode current collector 21A. Note, however, that the positive electrode active material layer 21B may be provided only on one of the two opposed surfaces of the positive electrode current collector 21A on a side where the positive electrode 21 is opposed to the negative electrode 22.

Specifically, the positive electrode active material layer 21B includes a positive electrode active material in the form of particles, as illustrated in FIG. 3. The positive electrode active material in the form of particles will hereinafter be referred to as “positive electrode active material particles 210”. The positive electrode active material particles 210 each include a center part 210X and a covering part 210Y.

The center part 210X includes any one or more of lithium composite oxides into which lithium is to be inserted and from which lithium is to be extracted. The lithium composite oxide has a layered rock-salt crystal structure, and includes lithium, nickel, and another element as constituent elements. The other element includes one or more other elements that include any one or more of elements other than lithium and nickel.

Note that in the lithium composite oxide, a content of nickel is set to be sufficiently high. Specifically, where a sum of the content of nickel in the lithium composite oxide and a content of the other element(s) in the lithium composite oxide is taken as 100 parts by mole, the content of nickel is greater than or equal to 80 parts by mole and less than or equal to 100 parts by mole. As is apparent from an upper limit of the content of nickel being 100 parts by mole, the lithium composite oxide may or may not include the other element(s) as the constituent element(s).

When the lithium composite oxide includes two or more other elements as the constituent elements, the content of the other elements in the lithium composite oxide described above is a sum of respective contents of the two or more other elements included in the lithium composite oxide as the constituent elements.

That is, where the content of nickel in the lithium composite oxide is denoted as C1 (mol) and the content of the other element(s) in the lithium composite oxide is denoted as C2 (mol), a content ratio C of nickel is calculable by the following calculation expression: C=[C1/(C1+C2)]×100. The content ratio C thus calculated is within a range from 80 mol % to 100 mol % both inclusive.

One reason why the content ratio C is set to the range from 80 mol % to 100 mol % both inclusive is that, as compared with a case where the content ratio C is less than 80 mol %, a potential at which lithium is inserted and extracted is lower and therefore a higher battery capacity is obtainable.

Although not particularly limited in kind, specific examples of the other elements include cobalt, aluminum, manganese, zirconium, titanium, molybdenum, tantalum, chromium, niobium, iron, copper, zinc, vanadium, magnesium, tungsten, sulfur, strontium, boron, sodium, and fluorine. One reason for this is that a sufficient battery capacity is obtainable.

More specifically, the lithium composite oxide includes any one or more of compounds represented by Formula (1). The compounds represented by Formula (1) each include the other element(s) E as the constituent element(s).

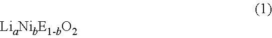

where:
E is at least one of Co, Al, Mn, Zr, Ti, Mo, Ta, Cr, Nb, Fe, Cu, Zn, V, Mg, W, S, Sr, B, Na or F; and
a and b satisfy 0.8≤a≤1.05 and 0.8≤b≤1.0.

Note that the positive electrode active material layer 21B may further include any one or more of other positive electrode active materials into which lithium is to be inserted and from which lithium is to be extracted. The other positive electrode active materials include a lithium-containing compound. The above-described lithium composite oxide is excluded from the lithium-containing compound described here.

The lithium-containing compound is a compound that includes lithium and one or more transition metal elements as constituent elements. The lithium-containing compound may further include one or more additional elements as one or more constituent elements. The one or more additional elements (excluding lithium and transition metal elements) are not particularly limited in kind, and are specifically any one or more of elements belonging to groups 2 to 15 in the long period periodic table. The lithium-containing compound is not particularly limited in kind, and is specifically, for example, an oxide, a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The covering part 210Y is provided on a surface of the center part 210X, and thus covers the surface of the center part 210X.

Here, the covering part 210Y covers all of the surface of the center part 210X. However, the covering part 210Y may cover only a part of the surface of the center part 210X. In such a case, two or more covering parts 210Y separated from each other may cover respective parts of the surface of the center part 210X.

The covering part 210Y includes a material including a second negative secondary ion derived from LiBO₂F⁻ to be described later. A composition of the material included in the covering part 210Y is not particularly limited as long as the covering part 210Y includes the second negative secondary ion.

One reason why the covering part 210Y is provided on the surface of the center part 210X and the covering part 210Y includes the material including the second negative secondary ion is that this suppresses an increase in electric resistance of the positive electrode 21 even when the lithium composite oxide (content ratio C≥80 mol %) is used as the material included in the center part 210X.

More specifically, as described above, a high battery capacity is obtainable by the use of the lithium composite oxide (content ratio C≥80 mol %) as the material included in the center part 210X.

However, the use of the lithium composite oxide (content ratio C≥80 mol %) increases activity of a surface of the positive electrode 21 upon charging, which makes it easier for the electrolytic solution to undergo oxidative decomposition at the surface of the positive electrode 21. As a result of the oxidative decomposition of the electrolytic solution, a decomposition product acting as a resistance component is easily formed, and the decomposition product easily deposits on the surface of the center part 210X. This tends to hinder a charge transfer reaction in the center part 210X, and thus causes the electric resistance of the positive electrode 21 to easily increase. Accordingly, the battery capacity easily decreases upon repeated charging and discharging.

However, if the covering part 210Y is provided on the surface of the center part 210X and three physical property conditions to be described later are satisfied regarding physical properties of the positive electrode active material layer 21B, the surface of the center part 210X is electrochemically protected by the covering part 210Y. The covering part 210Y is highly resistant to oxidation, and has no electron conductivity although having ion conductivity. Accordingly, the covering part 210Y suppresses formation of the decomposition product and suppresses deposition of the decomposition product on the surface of the center part 210X. Hindrance to the charge transfer reaction is thus suppressed, and the oxidative decomposition of the electrolytic solution at the surface of the center part 210X is also suppressed. This helps to prevent the electric resistance of the positive electrode 21 from easily increasing, and thus helps to prevent the battery capacity from easily decreasing even upon repeated charging and discharging.

As described above, the covering part 210Y includes the material including the second negative secondary ion. Accordingly, the covering part 210Y preferably includes lithium, boron, and fluorine as constituent elements. One reason for this is that this makes it easier for the covering part 210Y to electrochemically protect the surface of the center part 210X.

In particular, it is more preferable that the covering part 210Y include lithium fluoroborate (LiBOF₂). One reason for this is that this makes it easier to form the covering part 210Y and allows the covering part 210Y to electrochemically sufficiently cover the surface of the center part 210X.

As will be described later, the covering part 210Y is formed on the surface of the center part 210X using a covering source material in a manufacturing process of the secondary battery, more specifically, in a stabilization process of the secondary battery, i.e., a first charging and discharging process, after assembling the secondary battery. In this case, the covering source material decomposes and reacts in the stabilization process, thereby forming the covering part 210Y to cover the surface of the center part 210X.

The covering source material is a material including the constituent elements of the covering part 210Y. More specifically, the covering source material includes any one or more of materials serving as sources of boron and fluorine that are included in the covering part 210Y as the constituent elements. A location where the covering source material is present is not particularly limited as long as it is inside the secondary battery before undergoing the stabilization process.

The covering source material may include a material including boron as a constituent element (a boron-containing material) and a material including fluorine as a constituent element (a fluorine-containing material), or may be a material including boron and fluorine as constituent elements (a boron-and-fluorine-containing material).

Details of the covering source material, including the location where the covering source material is present and the kind of the covering source material, will be described later.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The other materials included in the positive electrode active material layer 21B may further include any one or more of materials other than the positive electrode binder and the positive electrode conductor described above.

Specifically, the other materials include a dispersant to be used in the manufacturing process of the secondary battery (i.e., a preparation process of a positive electrode mixture slurry) to be described later. The dispersant is a material that improves dispersibility of particles such as the positive electrode active material particles 210 in the positive electrode mixture slurry. Specific examples of the dispersant include polyvinylpyrrolidone.

The other materials further include any one or more of the covering source materials. Specific examples of the one or more covering source materials to be used in the positive electrode 21 include lithium metaborate (LiBO₂), i.e., the boron-containing material. As described above, the one or more covering source materials are used to form the covering part 210Y in the stabilization process of the secondary battery after being assembled.

In the secondary battery, predetermined conditions are satisfied regarding the physical properties of the positive electrode active material layer 21B to achieve an improved battery characteristic. Details of the physical properties of the positive electrode active material layer 21B will be described later.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes a negative electrode active material into which lithium is to be inserted and from which lithium is to be extracted. Note that the negative electrode active material layer 22B may further include any one or more of other materials including, without limitation, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note, however, that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that a high energy density is obtainable.

Specific examples of the carbon material include graphitizable carbon, non-graphitizable carbon, and graphite (natural graphite and artificial graphite).

The metal-based material is a material including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Note that the “simple substance” described here may contain a desired amount of impurity. Thus, purity of the “simple substance” does not necessarily have to be 100%. Specific examples of the metal-based material include TiSi₂ and SiOₓ (0<x≤2, or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows a lithium ion to pass therethrough while preventing the occurrence of a short circuit caused by contact between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents). The electrolytic solution including the non-aqueous solvent(s) is what is called a non-aqueous electrolytic solution. The non-aqueous solvent is, for example, an ester or an ether, and more specifically, a carbonic-acid-ester-based compound, a carboxylic-acid-ester-based compound, or a lactone-based compound, for example. One reason for this is that a dissociation property of the electrolyte salt improves and mobility of ions also improves.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include γ-butyrolactone and γ-valerolactone. Note that the ether may be, for example, 1,2-dimethoxyethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

Although not particularly limited, a content of the electrolyte salt is specifically within a range from 0.3 mol/kg to 3.0 mol/kg both inclusive with respect to the solvent. One reason for this is that high ion conductivity is obtainable.

Note that the electrolytic solution may further include any one or more of additives. One reason for this is that this improves electrochemical stability of the electrolytic solution. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

Note that the electrolytic solution may include any one or more of the covering source materials. Specific examples of the one or more covering source materials to be included in the electrolytic solution include lithium metaborate (LiBO₂) as the boron-containing material, lithium hexafluorophosphate (LiPF₆) as the fluorine-containing material, and lithium tetrafluoroborate (LiBF₄) as the boron-and-fluorine-containing material. As described above, the one or more covering source materials are used to form the covering part 210Y in the stabilization process of the secondary battery after being assembled.

As illustrated in FIGS. 1 and 2, the positive electrode lead 31 is a positive electrode wiring coupled to the positive electrode current collector 21A, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode current collector 22A, and is led to the outside of the outer package film 10. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to the details of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

In the secondary battery, as described above, the predetermined conditions are satisfied regarding the physical properties of the positive electrode active material layer 21B to achieve an improved battery characteristic. A description is given below of a case where the covering part 210Y includes lithium fluoroborate (LiBOF₂).

FIG. 4 illustrates a result of analysis of the positive electrode active material layer 21B in a depth direction D by time-of-flight secondary ion mass spectrometry (TOF-SIMS). In FIG. 4, the horizontal axis represents sputtering time (seconds), and the vertical axis represents ionic strength (counts).

The positive electrode active material layer 21B is subjected to analysis in the depth direction D by the TOF-SIMS. The analysis by the TOF-SIMS to be described here is what is called depth analysis. As illustrated in FIG. 2, the depth direction D is a direction corresponding to a thickness direction of the positive electrode active material layer 21B, and more specifically, a direction from the surface of the positive electrode active material layer 21B toward an interior of the positive electrode active material layer 21B.

In the depth analysis, a normal ion analysis using primary ions and sputter etching to etch down the positive electrode active material layer 21B using sputter ions are alternately repeated in the depth direction D. As a result, the amounts of various kinds of ions detected from the positive electrode active material layer 21B in the depth direction D are measurable. Thus, an analysis result on the positive electrode active material layer 21B in the depth direction D is acquirable, as illustrated in FIG. 4.

The horizontal axis represents the sputtering time during the sputter etching as described above, and thus corresponds to a position in the depth direction D (in other words, a depth) in the interior of the positive electrode active material layer 21B. The horizontal axis represents the ionic strength as described above, and thus corresponds to the detection amount of each of the various kinds of ions in the depth direction D.

Here, as illustrated in FIG. 3, the positive electrode active material particle 210 includes the center part 210X and the covering part 210Y. The center part 210X includes the lithium composite oxide in which the content ratio C is greater than or equal to 80 mol %. The covering part 210Y includes lithium fluoroborate. In this case, two kinds of negative secondary ions are detectable through the analysis of the positive electrode active material layer 21B in the depth direction D by the TOF-SIMS. The two kinds of negative secondary ions include a first negative secondary ion derived from NiO₂⁻ and a second negative secondary ion derived from LiBO₂F⁻.

As a result, as illustrated in FIG. 4, a first depth profile 4A and a second depth profile 4B are acquirable. The first depth profile 4A indicates a change in ionic strength of the first negative secondary ion in the depth direction D. The second depth profile 4B indicates a change in ionic strength of the second negative secondary ion in the depth direction D.

When the covering part 210Y covers the surface of the center part 210X and the covering part 210Y includes lithium fluoroborate, the three physical property conditions described below are satisfied.

In the first depth profile 4A, the ionic strength of the first negative secondary ion increases in the depth direction D because a detection amount of the first negative secondary ion increases as the sputtering time increases. In this case, at some point along the depth direction D, that is, midway through the increase in the ionic strength of the first negative secondary ion, the ionic strength of the first negative secondary ion can exhibit a sharp increase.

One reason why the ionic strength of the first negative secondary ion increases in the depth direction D is as described below.

In the positive electrode active material layer 21B, as described above, not only the positive electrode active material particles 210 but also the positive electrode binder, the positive electrode conductor, etc. are present together. A part of the positive electrode active material particle 210, i.e., the center part 210X, includes a large amount of nickel as a constituent element, whereas the positive electrode binder, the positive electrode conductor, etc. each include hardly any amount of nickel as a constituent element. In this case, through the analysis of the positive electrode active material layer 21B in the depth direction D by the TOF-SIMS, the first negative secondary ion is detectable in a region where nickel is present in a sufficient amount, whereas in a region where nickel is almost absent, the first negative secondary ion is not detectable.

Accordingly, if the positive electrode active material layer 21B is analyzed in the depth direction D by the TOF-SIMS, the analysis result indicates that, as described above, the detection amount of the first negative secondary ion increases in the depth direction D and therefore the ionic strength of the first negative secondary ion increases in the depth direction D.

In particular, when hardly any positive electrode active material particles 210 are present in the vicinity of an uppermost surface of the positive electrode active material layer 21B, the ionic strength of the first negative secondary ion increases gradually, whereas in the interior of the positive electrode active material layer 21B, the positive electrode active material particles 210 are present in abundance and therefore the ionic strength of the first negative secondary ions increases sharply. As a result, the ionic strength of the first negative secondary ion increases in the depth direction D first gradually, and thereafter sharply. Accordingly, as described above, the ionic strength of the first negative secondary ion can increase sharply at some point along the depth direction D.

In the second depth profile 4B, the ionic strength of the second negative secondary ion decreases in the depth direction D because a detection amount of the second negative secondary ion decreases as the sputtering time increases.

One reason why the ionic strength of the second negative secondary ion decreases in the depth direction D is as described below.

In the stabilization process of the secondary battery after being assembled, the covering source material decomposes and reacts, and multiple kinds of compounds present in an interior of the assembled secondary battery also decompose and react. As a result, a film including a variety of decomposition products and reaction products is formed on the surface of the positive electrode active material layer 21B. Specific examples of the multiple kinds of compounds include the solvent and the electrolyte salt included in the electrolytic solution.

The variety of decomposition products and reaction products included in the film can include large amounts of boron and fluorine as constituent elements. In contrast, the positive electrode binder, the positive electrode conductor, etc. included in the positive electrode active material layer 21B each do not include so large amounts of boron and fluorine as constituent elements as those in the film described above. In such a case, through the analysis of the positive electrode active material layer 21B in the depth direction D by the TOF-SIMS, the second negative secondary ion is detectable in a region where boron and fluorine are present in sufficient amounts, whereas in a region where boron and fluorine are almost absent, the second negative secondary ion is not detectable.

Accordingly, if the positive electrode active material layer 21B is analyzed in the depth direction D by the TOF-SIMS, the analysis result indicates that, as described above, the detection amount of the second negative secondary ion decreases in the depth direction D and therefore the ionic strength of the second negative secondary ion decreases in the depth direction D.

The second depth profile 4B includes a stepped region S in which the ionic strength of the second negative secondary ion temporarily stops decreasing in the depth direction D midway through the increase in the ionic strength of the first negative secondary ion in the depth direction D.

In the stepped region S, the ionic strength of the second negative secondary ion may be constant in the depth direction D or may increase in the depth direction D, or the stepped region S may include both a region in which the ionic strength of the second negative secondary ion is constant in the depth direction D and a region in which the ionic strength of the second negative secondary ion increases in the depth direction D.

One reason why the second depth profile 4B includes the stepped region S is as described below.

As described above, in the stabilization process of the secondary battery after being assembled, the film is formed on the surface of the positive electrode active material layer 21B owing to the decomposition and the reactions of not only the covering source material but also the multiple kinds of compounds. This causes the ionic strength of the second negative secondary ion to decrease in the depth direction D.

However, a part of the positive electrode active material particle 210, i.e., the covering part 210Y, includes lithium fluoroborate, and therefore includes large amounts of boron and fluorine as the constituent elements. In this case, through the analysis of the positive electrode active material layer 21B in the depth direction D by TOF-SIMS, the second negative secondary ion is detectable in the region where boron and fluorine are present in sufficient amounts, whereas in the region where boron and fluorine are almost absent, the second negative secondary ion is not detectable.

Accordingly, if the positive electrode active material layer 21B is analyzed in the depth direction D by the TOF-SIMS, the analysis result indicates that the ionic strength of the second negative secondary ion decreases in the depth direction D and when an analysis position in the depth direction D reaches the covering part 210Y, the ionic strength of the second negative secondary ion temporarily increases. As a result, the ionic strength of the second negative secondary ion temporarily stops decreasing. Thereafter, when the analysis position in the depth direction D reaches the center part 210X, the ionic strength of the second negative secondary ion decreases again. The second depth profile 4B thus includes the stepped region S in which the ionic strength of the second negative secondary ion temporarily stops decreasing at some point along the depth direction D.

When the positive electrode active material particle 210 does not include the covering part 210Y (lithium fluoroborate) but includes only the center part 210X (lithium composite oxide in which the content ratio C is greater than or equal to 80 mol %), the first depth profile 4A is acquirable, and a third depth profile 4C is acquirable instead of the second depth profile 4B.

FIG. 4 illustrates the first depth profile 4A and the second depth profile 4B in solid lines and the third depth profile 4C in a dashed line.

In the third depth profile 4C, the ionic strength of the second negative secondary ion decreases in the depth direction D because the covering part 210Y is absent in the interior of the positive electrode active material layer 21B. In other words, the ionic strength of the second negative secondary ion does not temporarily increase at any point along the depth direction D and therefore continuously decreases in the depth direction D without temporarily stopping decreasing at any point along the depth direction D. As a result, the third depth profile 4C does not include the stepped region S, unlike the second depth profile 4B.

Note that when the positive electrode active material particle 210 includes the covering part 210Y but the covering part 210Y is not sufficient in amount of formation, the third depth profile 4C is acquirable instead of the second depth profile 4B, as with the case where the positive electrode active material particle 210 does not include the covering part 210Y.

As described above, whether or not the positive electrode active material particle 210 includes the center part 210X (lithium composite oxide in which the content ratio C is greater than or equal to 80 mol %) and the covering part 210Y (lithium fluoroborate) is identifiable post hoc, i.e., after completion of the secondary battery, through analyzing the positive electrode active material layer 21B in the depth direction D by the TOF-SIMS.

In other words, if the three physical property conditions described above are found to be satisfied through the analysis of the positive electrode active material layer 21B in the depth direction D by the TOF-SIMS, it is proven that the positive electrode active material particle 210 includes the center part 210X (lithium composite oxide in which the content ratio C is greater than or equal to 80 mol %) and the covering part 210Y (lithium fluoroborate).

Here, as an analyzer for the TOF-SIMS, TOF-SIMS analyzer TOF-SIMS V available from IONTOF GmbH is usable. Conditions for analysis are set as follows: primary ion: Bi³⁺; acceleration voltage of an ion gun: 25 keV; analysis mode: depth direction analysis in a high current bunched mode; current of applied ions (measured in the form of a pulse beam): 0.2 pA; pulse frequency: 10 kHz; mass range: 1 amu to 800 amu; scanning range: 200 μm×200 μm; sputtering ion: Ar+; acceleration voltage of a sputtering ion gun: 1 kV; emission current: 200 mA; and sputtering area: 500 μm×500 μm.

The following will describe a procedure of determining whether or not the three physical property conditions are satisfied through analyzing the positive electrode active material layer 21B in the depth direction D by the TOF-SIMS.

First, the secondary battery is discharged until a voltage reaches 2.0 V. A current at the time of discharging is not particularly limited, and may be set as desired.

Thereafter, the secondary battery is disassembled in a glove box to thereby retrieve the positive electrode 21, following which the positive electrode 21 is washed with a washing solvent. This removes the electrolytic solution with which the positive electrode 21 has been impregnated. The washing solvent is not particularly limited in kind, and specifically includes any one or more of organic solvents, such as dimethyl carbonate.

Thereafter, the washed positive electrode 21 is attached to a sample holder with an adhesive tape. The adhesive tape is not particularly limited in kind, and specific examples thereof include a carbon tape. Thereafter, the positive electrode active material layer 21B is analyzed in the depth direction D by the TOF-SIMS to thereby acquire an analysis result, as illustrated in FIG. 4.

Lastly, based on the analysis result, whether or not the three physical property conditions are satisfied is visually determined.

Specifically, when the ionic strength of the first negative secondary ion increases in the depth direction D and the first depth profile 4A is thus acquired, the positive electrode active material particles 210 (the center parts 210X including the lithium composite oxide in which the content ratio C is greater than or equal to 80 mol %) are present in the interior of the positive electrode active material layer 21B and therefore the first physical property condition is satisfied.

When the ionic strength of the second negative secondary ion decreases in the depth direction D and the second depth profile 4B is thus acquired, the second physical property condition is satisfied.

Further, when the second depth profile 4B includes the stepped region S even though the ionic strength of the second negative secondary ion decreases in the depth direction D, the positive electrode active material particles 210 (the covering parts 210Y including lithium fluoroborate) are present in the interior of the positive electrode active material layer 21B and therefore the third physical property condition is satisfied.

Note that when the third depth profile 4C without the stepped region S is acquired instead of the second depth profile 4B with the stepped region S, the positive electrode active material particles 210 include no covering parts 210Y, or even if the positive electrode active material particles 210 include the covering parts 210Y, the amount of formation of the covering parts 210Y is not sufficient; therefore, the second physical property condition is not satisfied.

Reasons for using the TOF-SIMS (depth analysis) as an analysis method for examining the physical properties of the positive electrode active material layer 21B are as described below.

Firstly, the covering part 210Y has a thickness of about several nanometers, and is therefore assumed to be markedly thin. In this case, to examine the physical properties of the positive electrode active material layer 21B in the depth direction D, it is effective to employ the TOF-SIMS (depth analysis) that is markedly high in depth resolution.

Secondly, when multiple kinds of compounds are present in the interior of the positive electrode active material layer 21B, it is effective to use the TOF-SIMS that makes it possible to examine individual compositions of the multiple kinds of compounds, rather than using an analysis method that makes it possible to examine an average composition of the positive electrode active material layer 21B.

More specifically, an analysis method such as X-ray photoelectron spectroscopy (XPS) or electron energy loss spectroscopy (TEM-EELS) is typically used to examine the composition of a film or the like.

However, for XPS, a spectrum derived from boron and a spectrum derived from phosphorus overlap each other, which makes it difficult to examine a chemical bonding state of boron, and to examine even the presence or absence of boron.

Further, when the TEM-EELS (particle section analysis) is employed to perform line analysis on a film in the depth direction D, an average composition including lithium, boron, oxygen, and fluorine is analyzed in a state where not only lithium fluoroborate but also other compounds are included, which makes it difficult to analyze only the lithium fluoroborate.

In contrast, the TOF-SIMS allows for analysis of an average composition including lithium, boron, oxygen, and lithium for only lithium fluoroborate. Accordingly, it is possible to analyze only the lithium fluoroborate.

Thirdly, although surface analysis by the TOF-SIMS allows for analysis of a variety of ions present at a surface of a film, it is difficult by this method to analyze a variety of ions present in an interior of the film.

In contrast, depth analysis by the TOF-SIMS allows for analysis of not only a variety of ions present at the surface of a film but also a variety of ions present in the interior of the film. This makes it possible to analyze a variety of ions related to the positive electrode active material layer 21B, and more specifically, to analyze even a variety of ions present in the interior of the covering part 210Y provided on the surface of the center part 210X.

The secondary battery exhibits the following operation in the battery device 20.

Upon charging, lithium is extracted from the positive electrode 21, and the extracted lithium is inserted into the negative electrode 22 via the electrolytic solution. Upon discharging, lithium is extracted from the negative electrode 22, and the extracted lithium is inserted into the positive electrode 21 via the electrolytic solution. Upon the discharging and the charging, lithium is inserted and extracted in an ionic state.

To manufacture the secondary battery, the positive electrode 21 and the negative electrode 22 are fabricated and the electrolytic solution is prepared, following which the secondary battery is assembled using the positive electrode 21, the negative electrode 22, and the electrolytic solution, and the assembled secondary battery is subjected to the stabilization process, in accordance with an example procedure described below.

The following will describe a method of manufacturing the secondary battery in a case where the covering part 210Y includes lithium fluoroborate.

First, the center parts 210X each including the lithium composite oxide (content ratio C≥80 mol %) are prepared. The lithium composite oxide includes residual alkali components in an interior thereof. The residual alkali components include alkali compounds including, for example, lithium hydroxide (LiOH) and lithium carbonate (Li₂CO₃). Note that the residual alkali components are present mainly at grain boundaries in the interior of the lithium composite oxide.

Thereafter, the center parts 210X are heated in a pressurized environment. A heating condition including pressure (Pa) in the environment, heating temperature (° C.), and heating time (hours) may be set as desired. As a result, the residual alkali components included in the center parts 210X are heated and thereby diffused to the surfaces of the center parts 210X. This makes it easier for the residual alkali components to be uniformly present at the surfaces of the center parts 210X.

One reason for heating the center parts 210X and thereby allowing the residual alkali components to be diffused to the surfaces of the center parts 210X is that this makes it easier to form the covering parts 210Y through reactions between the residual alkali components and the covering source material in the later-described stabilization process of the secondary battery after being assembled.

Note that a content (wt %) of the residual alkali components in the center parts 210X is not particularly limited as long as the covering parts 210Y are formed through the use of the residual alkali components. The content of the residual alkali components is calculable based on the following calculation expression: content of residual alkali components=(weight of residual alkali components/weight of center parts 210X)×100. In this case, an amount of the residual alkali components diffused to the surfaces of the center parts 210X is controllable by changing the heating condition described above.

A procedure of calculating the content of the residual alkali components in the center parts 210X is as described below. First, a weight M1 of the center parts 210X is measured. Thereafter, a weight M2 of the residual alkali components included in the center parts 210X is measured by a two-stage neutralization titration method (a Warder method) to be described later. Lastly, the content of the residual alkali components is calculated based on the above-described calculation expression.

A procedure of measuring the weight M2 of the residual alkali components by the two-stage neutralization titration method is as described below.

The center parts 210X are put into pure water, following which the pure water is stirred to thereby prepare an aqueous residual alkali solution. The weight M2 of the residual alkali components is a weight of the residual alkali components included in an aqueous supernatant of the aqueous residual alkali solution, and more specifically, a total weight of lithium hydroxide and lithium carbonate included in the aqueous supernatant of the aqueous residual alkali solution.

Because the aqueous supernatant of the aqueous residual alkali solution is an aqueous solution including the residual alkali components, the weight M2 of the residual alkali components is measurable based on a titration amount of an acid necessary for neutralization titration of the aqueous supernatant until a neutralization point is reached. In this case, the aqueous residual alkali solution may be diluted with pure water. The neutralization point in the neutralization titration is to be identified by an electrometric titration method. In the electrometric titration method, a point at which a rate of change of a measured potential is the highest with respect to the titration amount of the acid serves as a first neutralization point (a final neutralization point), and a point at which the rate of change of the measured potential is the second highest with respect to the titration amount of the acid serves as a first neutralization point.

In the neutralization titration, hydrochloric acid having a concentration of 0.1 mol/l (=0.1 mol/dm³) may be used as the acid for titrating the aqueous residual alkali solution. In such a case, neutralization reactions represented by reaction formulae (1) to (3) proceed, and therefore the weight M2 of the residual alkali components is calculable by using calculation expression (4). The reaction formulae (1) and (2) represent neutralization reactions to proceed to the first neutralization point, and the reaction formula (3) represents a neutralization reaction to proceed from the first neutralization point to the second neutralization point.

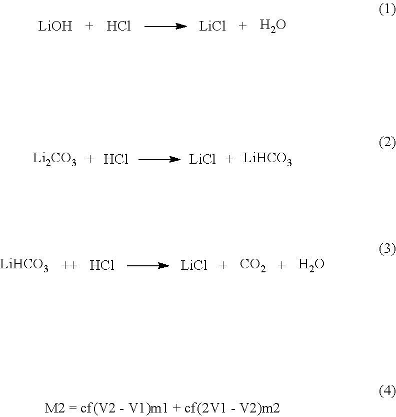

In calculation expression (4), M2 represents the weight of the residual alkali components, c represents the concentration of the hydrochloric acid used in the neutralization titration, f represents a factor value of the hydrochloric acid (a coefficient for correcting the concentration of the hydrochloric acid) used in the neutralization titration, V1 represents a volume of the hydrochloric acid needed to reach the first neutralization point, V2 represents a volume of the hydrochloric acid needed to reach the second neutralization point, m1 represents a molecular weight of lithium carbonate, and m2 represents a molecular weight of lithium hydroxide.

Thereafter, the heated positive electrode active material particles 210, the positive electrode binder, and the positive electrode conductor are mixed with each other to thereby obtain a positive electrode mixture. Thereafter, the positive electrode mixture is put into a solvent to thereby prepare the positive electrode mixture slurry in paste form. The solvent may be an aqueous solvent or an organic solvent.

Thereafter, the positive electrode mixture slurry is applied on the two opposed surfaces of the positive electrode current collector 21A to thereby form precursor layers (not illustrated). The precursor layers each have a configuration similar to the configuration of the positive electrode active material layer 21B except that the covering part 210Y is not provided on the surface of the center part 210X and that the precursor layers are unimpregnated with the electrolytic solution. Thereafter, the precursor layers may be compression-molded by means of a machine such as a roll pressing machine. In this case, the precursor layers may be heated. The precursor layers may be compression-molded multiple times.

Lastly, as will be described later, the secondary battery is assembled, following which the stabilization process is performed on the assembled secondary battery. Thus, the covering parts 210Y are formed on the surfaces of the center parts 210X, and the positive electrode active material particles 210 are thereby formed. Accordingly, the positive electrode active material layers 21B each including the positive electrode active material particles 210 are formed. As a result, the positive electrode 21 is fabricated.

In a case of using the covering source material in the fabrication process of the positive electrode 21, the positive electrode 21 is fabricated in accordance with the following procedure.

First, the center parts 210X and the covering source material in powder form are mixed with each other. As described above, the covering source material includes the boron-containing material such as lithium metaborate. The covering source material in powder form thus adheres to the surfaces of the center parts 210X. The covering source material adhering to the surfaces of the center parts 210X is used to form the covering parts 210Y in a later step, as described above.

Thereafter, the positive electrode mixture slurry is prepared in accordance with the above-described procedure by using the center parts 210X with the covering source material in powder form adhering to the surfaces of the center parts 210X, following which the precursor layers are formed using the positive electrode mixture slurry.

Lastly, the secondary battery is assembled, following which the stabilization process is performed on the assembled secondary battery. The covering parts 210Y are thus formed on the surfaces of the center parts 210X through the use of the covering source material in powder form adhering to the surfaces of the center parts 210X. The positive electrode active material layers 21B are thereby formed. Thus, the positive electrode 21 is fabricated through the formation of the positive electrode active material layers 21B each including the positive electrode active material particles 210.

First, the negative electrode active material, the negative electrode binder, and the negative electrode conductor are mixed with each other to thereby obtain a negative electrode mixture. Thereafter, the negative electrode mixture is put into a solvent to thereby prepare a negative electrode mixture slurry in paste form. Details of the solvent are as described above. Lastly, the negative electrode mixture slurry is applied on the two opposed surfaces of the negative electrode current collector 22A to thereby form the negative electrode active material layers 22B. Thereafter, the negative electrode active material layers 22B may be compression-molded by means of a machine such as a roll pressing machine. In this case, the negative electrode active material layers 22B may be heated. The negative electrode active material layers 22B may be compression-molded multiple times. As a result, the negative electrode 22 is fabricated.

The electrolyte salt is put into the solvent. The electrolyte salt is thereby dispersed or dissolved in the solvent. As a result, the electrolytic solution is prepared.

In a case of using the covering source material in a preparation process of the electrolytic solution, an electrolyte salt that also serves as the covering source material may be used. The electrolyte salt that also serves as the covering source material includes the fluorine-containing material such as lithium hexafluorophosphate, as described above.

Alternatively, in the case of using the covering source material in the preparation process of the electrolytic solution, the covering source material may be added to the solvent after putting the electrolyte salt into the solvent. As described above, the covering source material includes the boron-containing material such as lithium tetrafluoroborate. The covering source material is thus dispersed or dissolved in the solvent. As a result, the electrolytic solution including the covering source material is prepared. The covering source material included in the electrolytic solution is used to form the covering parts 210Y in the stabilization process of the secondary battery after being assembled.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as the welding method.

Thereafter, the positive electrode current collector 21A on which the precursor layers are formed and the negative electrode current collector 22A on which the negative electrode active material layers 22B are formed are stacked on each other with the separator 23 interposed therebetween to thereby form a stacked body (not illustrated). Thereafter, the stacked body is wound to thereby fabricate a wound body (not illustrated), following which the wound body is pressed by a machine such as a pressing machine to thereby shape the wound body into an elongated shape. The wound body having been shaped has a configuration similar to the configuration of the battery device 20 except that the precursor layers are included instead of the positive electrode active material layers 21B and that the wound body is unimpregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution and sealed in the outer package film 10 having the pouch shape. Thus, the secondary battery is assembled.

The secondary battery after being assembled is charged and discharged. Various conditions including, for example, an environment temperature, the number of times of charging and discharging (the number of cycles), and charging and discharging conditions, may be set as desired.

The covering parts 210Y are thereby formed on the surfaces of the center parts 210X to form the positive electrode active material particles 210. The positive electrode active material layers 21B including the positive electrode active material particles 210 are thus formed. As a result, the positive electrode 21 is fabricated.

Further, a film is formed on the surface of the positive electrode 21, which electrochemically stabilizes the positive electrode 21, and a film is formed on the surface of the negative electrode 22, which electrochemically stabilizes the negative electrode 22.

Here, in a case where a boron-containing material such as lithium metaborate is used as the covering source material (the boron-containing material) in the fabrication process of the positive electrode 21 and lithium hexafluorophosphate is used as the electrolyte salt that also serves as the covering source material (the fluorine-containing material) in the preparation process of the electrolytic solution, the covering parts 210Y including lithium fluoroborate are formed through a reaction between the covering source materials described below.

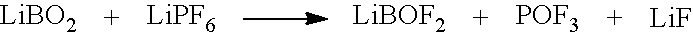

Further, in a case where lithium tetrafluoroborate is used as the covering source material (the boron-and-fluorine-containing material) in the preparation process of the electrolytic solution, the covering parts 210Y including lithium fluoroborate are formed through reactions between the covering source material and the residual alkali components described below.

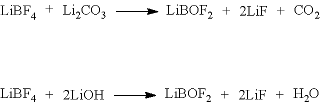

As a result of the foregoing, the battery device 20 is fabricated, and the fabricated battery device 20 is sealed in the outer package film 10 having the pouch shape. The secondary battery is thus completed.

According to the above-described secondary battery, the positive electrode active material layer 21B includes the positive electrode active material particles 210, the positive electrode active material particles 210 each include the center part 210X and the covering part 210Y, and the center part 210X includes the lithium composite oxide (content ratio C≥80 mol %). Further, the three physical property conditions described above are satisfied regarding the result of analysis of the positive electrode active material layer 21B in the depth direction D by the TOF-SIMS.

In this case, because the center part 210X includes the lithium composite oxide (content ratio C≥80 mol %), it is possible to obtain a high battery capacity, as described above.

Moreover, because the covering part 210Y is provided on the surface of the center part 210X and the three physical property conditions are satisfied regarding the physical properties of the positive electrode active material layer 21B, the surface of the center part 210X is electrochemically protected by the covering part 210Y even if the center part 210X includes the lithium composite oxide (content ratio C≥80 mol %), as described above. Accordingly, hindrance to the charge transfer reaction is suppressed, and the oxidative decomposition of the electrolytic solution at the surface of the center part 210X is also suppressed. This prevents the electric resistance of the positive electrode 21 from easily increasing. As a result, the battery capacity is prevented from easily decreasing even upon repeated charging and discharging.

For the reasons described above, a high battery capacity is obtainable even when the lithium composite oxide (content ratio C≥80 mol %) is used as the material to be included in the center part 210X, and furthermore, the covering part 210Y serves to prevent the electric resistance of the positive electrode 21 from easily increasing. This makes it possible to achieve a superior battery characteristic.

In particular, the covering part 210Y may include lithium, boron, and fluorine as the constituent elements. This makes it easier to form the covering part 210Y. Accordingly, it is possible to achieve higher effects. In this case, the covering part 210Y may include lithium fluoroborate. This allows the surface of the center part 210X to be electrochemically sufficiently protected by the covering part 210Y. Accordingly, it is possible to achieve even higher effects.

Further, the lithium composite oxide may include, as other element(s), any one or more of cobalt, aluminum, manganese, zirconium, titanium, molybdenum, tantalum, chromium, niobium, iron, copper, zinc, vanadium, magnesium, tungsten, sulfur, strontium, boron, sodium, or fluorine. This makes it possible to obtain a sufficient battery capacity. Accordingly, it is possible to achieve higher effects.

Further, the secondary battery may include a lithium-ion secondary battery. This makes it possible to stably obtain a sufficient battery capacity through insertion and extraction of lithium. Accordingly, it is possible to achieve higher effects.

The configuration of the secondary battery is appropriately modifiable including as described below according to one or more embodiments. Note that any two or more of the following series of modification examples may be combined with each other.

The description has been given of the case where the positive electrode 21 or the electrolytic solution includes the covering source material. However, a location where the covering source material is to be included is not particularly limited. Accordingly, the covering source material may be included in the negative electrode 22, or in two or more of the following locations: the positive electrode 21; the negative electrode 22; and the electrolytic solution.

In such a case also, the covering part 210Y is formed in the stabilization process of the secondary battery after being assembled. Accordingly, it is possible to achieve similar effects.

The description has been given of the case where the covering part 210Y is formed after the assembly of the secondary battery by using the stabilization process of the assembled secondary battery to form the covering part 210Y. However, the covering part 210Y may be formed before the assembly of the secondary battery without using the stabilization process to form the covering part 210Y.

A procedure of fabricating the positive electrode 21 in the case of forming the covering part 210Y before the assembly of the secondary battery without using the stabilization process is as described below.

First, the material to be included in the covering part 210Y and a solvent for dispersion are mixed with each other to thereby prepare a process solution. The material to be included in the covering part 210Y is a material that allows for satisfaction of the three physical property conditions regarding the physical properties of the positive electrode active material layer 21B, and specifically includes the foregoing material such as lithium fluoroborate. The solvent for dispersion is not particularly limited in kind, and may thus be an aqueous solvent or an organic solvent.

In the case of preparing the process solution, a binder may be included in the process solution. Details of the binder are similar to the details of the positive electrode binder.

Thereafter, the process solution is applied on the surfaces of the center parts 210X, following which the process solution is dried to thereby form the covering parts 210Y. In this case, instead of applying the process solution on the surfaces of the center parts 210X, the center parts 210X may be immersed in the process solution, following which the center parts 210X may be taken out of the process solution and dried.

The covering parts 210Y are thereby formed on the surfaces of the center parts 210X. As a result, the positive electrode active material particles 210 are formed.

Lastly, in accordance with the foregoing procedure, the positive electrode active material layers 21B are formed using the positive electrode active material particles 210. The positive electrode 21 is thereby fabricated without using the stabilization process of the secondary battery after being assembled.

In this case also, the positive electrode active material particles 210 each including the center part 210X and the covering part 210Y are obtained. Accordingly, similar effects are achievable.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress misalignment of the battery device 20, that is, winding displacement of each of the positive electrode 21, the negative electrode 22, and the separator. This suppresses swelling of the secondary battery even if a decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may each include any one or more kinds of insulating particles. One reason for this is that the insulating particles dissipate heat upon heat generation by the secondary battery, thus improving safety or heat resistance of the secondary battery. The insulating particles include any one or more of insulating materials including, without limitation, inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include acrylic resin and styrene resin.

To fabricate the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed by suppression of the misalignment of the battery device 20, as described above. Accordingly, it is possible to achieve higher effects.

The electrolytic solution, i.e., a liquid electrolyte, is used. However, although not specifically illustrated here, an electrolyte layer may be used. The electrolyte layer is a gel electrolyte.

In the battery device 20 including the electrolyte layer, the positive electrode 21 and the negative electrode 22 are opposed to each other with the separator 23 and the electrolyte layer interposed therebetween, and are wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is prevented. The electrolytic solution has the configuration described above. The polymer compound includes, for example, polyvinylidene difluoride. To form the electrolyte layer, a precursor solution including, without limitation, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable in an ionic state between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will be described below in further detail according to an embodiment. The configuration described herein is merely an example, and is appropriately modifiable according to an embodiment.

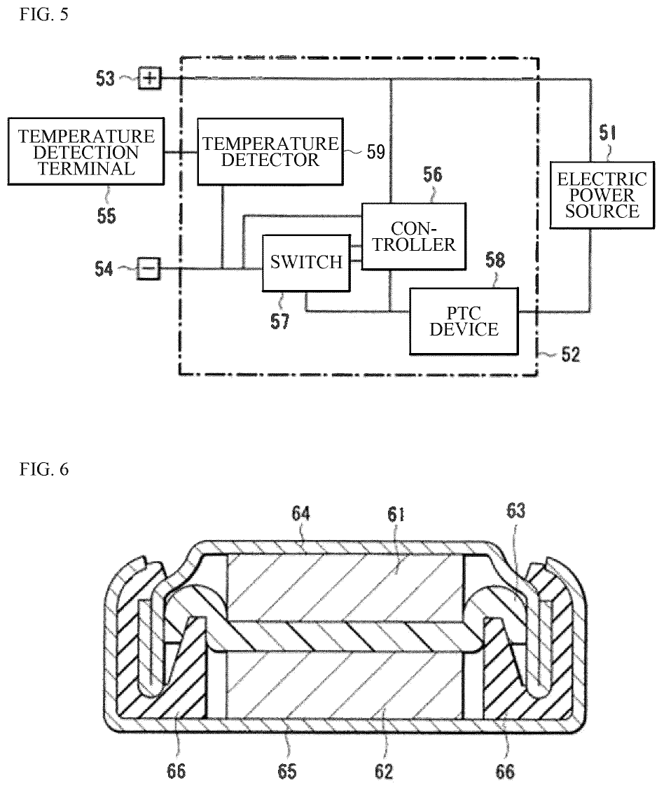

FIG. 5 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 5, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to an outside via the positive electrode terminal 53 and the negative electrode terminal 54, and is thus chargeable and dischargeable. The circuit board 52 includes a controller 56, a switch 57, a PTC device 58 that is a thermosensitive resistive device, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 4 and Comparative Examples 1 to 3

As described below, secondary batteries were fabricated and thereafter, the fabricated secondary batteries were each evaluated for a battery characteristic. Here, the secondary batteries for testing were used to evaluate the battery characteristic, as will be described later.

### Fabrication of Secondary Battery

FIG. 6 illustrates a sectional configuration of the secondary battery for testing. The secondary battery for testing was a secondary battery (a lithium-ion secondary battery) of what is called a coin type.

The secondary battery included a test electrode 61, a counter electrode 62, a separator 63, an outer package cup 64, an outer package can 65, a gasket 66, and an electrolytic solution (not illustrated).

The test electrode 61 was contained in the outer package cup 64, and the counter electrode 62 was contained in the outer package can 65. The test electrode 61 and the counter electrode 62 were stacked on each other with the separator 63 interposed therebetween. The test electrode 61, the counter electrode 62, and the separator 63 were impregnated with the electrolytic solution. The outer package cup 64 and the outer package can 65 were crimped to each other with the gasket 66 interposed therebetween. The test electrode 61, the counter electrode 62, and the separator 63 were thus sealed in the outer package cup 64 and the outer package can 65.

The secondary battery illustrated in FIG. 6 was fabricated by the following procedure.

### Fabrication of Test Electrode

First, the center parts including the lithium composite oxide (content ratio C≥80 mol %) were prepared. The composition of the lithium composite oxide, the content ratio C (mol %), and the content of the residual alkali components in the lithium composite oxide were as listed in Table 1.

Thereafter, the center parts were heated at a heating temperature of 650° for a heating time of 10 hours in a pressurized environment at a pressure of 1 MPa.

Thereafter, 95.5 parts by mass of the positive electrode active material particles having been heated, 2.5 parts by mass of the positive electrode binder (polyvinylidene difluoride), 1.9 parts by mass of the positive electrode conductor (carbon black), and 0.1 parts by mass of a dispersant (polyvinylpyrrolidone) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied to one of the two opposed surfaces of the positive electrode current collector (an aluminum foil having a thickness of 15 μm), following which the positive electrode mixture slurry was dried by heating at a heating temperature of 100° C. and a heating time of 15 minutes to thereby form a precursor layer having a thickness of 40 μm. Thereafter, the positive electrode current collector with the precursor layer formed thereon was punched into a disk shape having a diameter of 16.5 mm.

Lastly, as described later, the secondary battery was assembled, following which the stabilization process was performed on the assembled secondary battery. The covering parts including lithium fluoroborate (LiBOF₂) were thereby formed on the surfaces of the center parts. Thus, the positive electrode active material particles were formed.

The positive electrode active material layer including the positive electrode active material particles was thereby formed. As a result, the test electrode 61 was fabricated.

In a case where the covering source material was to be used in the fabrication process of the test electrode 61, after heating the center parts and before obtaining the positive electrode mixture including the center parts, the boron-containing material (lithium metaborate) in powder form was added to the center parts to thereby obtain a mixture, following which the mixture was stirred. This caused the boron-containing material in powder form to adhere to the surfaces of the center parts. The content of the covering source material (the boron-containing material) in the mixture was as listed in Table 1. Thereafter, the positive electrode mixture slurry was prepared using the center parts with the boron-containing material adhering to the surfaces thereof, following which the precursor layer was formed using the positive electrode mixture slurry.

### Fabrication of Counter Electrode

A lithium metal plate was punched into a disk shape having a diameter of 17 mm. The counter electrode 62 was thereby obtained.

### Preparation of Electrolytic Solution

An electrolyte salt (lithium hexafluorophosphate (LiPF₆)) serving also as the covering source material (the fluorine-containing material) was put into a solvent (ethylene carbonate as a cyclic carbonic acid ester and dimethyl carbonate as a chain carbonic acid ester), following which the solvent was stirred. A mixture ratio (weight ratio) between ethylene carbonate and dimethyl carbonate in the solvent was set to 30:70. The content of the electrolyte salt was set to 1 mol/l (=1 mol/dm³) with respect to the solvent. The electrolytic solution was thereby prepared.

In a case where the covering source material was to be used in the preparation process of the electrolytic solution, the boron-containing material (lithium tetrafluoroborate (LiBF₄)) was added to the electrolytic solution, following which the electrolytic solution was stirred. The content (wt %) of the covering source material (the boron-containing material) in the electrolytic solution was as listed in Table 1.

### Assembly of Secondary Battery

First, the test electrode 61 including the precursor layer was placed into the outer package cup 64, and the counter electrode 62 was placed into the outer package can 65. Thereafter, the test electrode 61 placed in the outer package cup 64 and the counter electrode 62 placed in the outer package can 65 were stacked on each other, with the separator 63 (a disk-shaped polyethylene film having a diameter of 17.5 μm) impregnated with the electrolytic solution being interposed between the test electrode 61 and the counter electrode 62. In this case, the test electrode 61 was so disposed that the precursor layer and the counter electrode 62 faced toward each other with the separator 63 interposed therebetween. Thereafter, the outer package cup 64 and the outer package can 65 were crimped to each other with the gasket 66 interposed therebetween in a state where the test electrode 61 and the counter electrode 62 were stacked on each other with the separator 63 interposed therebetween. The test electrode 61 and the counter electrode 62 were thereby sealed in the outer package cup 64 and the outer package can 65. The secondary battery was thus assembled.

### Stabilization of Secondary Battery after Assembly

The secondary battery after being assembled was charged and discharged for one cycle.

Upon charging, the secondary battery was first charged in an ambient temperature environment (at a temperature of 25° C.) with a constant current of 0.1 C until a voltage reached 4.0 V. Thereafter, the secondary battery was charged in a high-temperature environment (at a temperature of 70° C.) with a constant current of 0.1 C until the voltage reached 4.3 V. Lastly, the secondary battery was charged in the high-temperature environment at a constant voltage of 4.3 V until the current reached 0.01 C.

Upon discharging, the secondary battery was discharged in the ambient temperature environment with a constant current of 0.1 C until the voltage reached 2.5 V.

Note that 0.1 C was a value of a current that caused a battery capacity (a theoretical capacity) to be completely discharged in 10 hours, and 0.01 C was a value of a current that caused the battery capacity to be completely discharged in 100 hours.

The covering parts were thereby formed on the surfaces of the center parts. Thus, the positive electrode active material particles were formed. The positive electrode active material layer including the positive electrode active material particles were thereby formed and thus the test electrode 61 was fabricated. As a result, the secondary battery was completed.

A secondary battery for comparison was fabricated by a similar procedure except that no covering source material was used (except for the electrolyte salt serving also as the covering source material). In this case, no covering parts 210Y were formed.

After the secondary battery was completed, the test electrode 61 was subjected to depth analysis by the TOF-SIMS to thereby examine the physical properties, that is, whether or not the three physical property conditions were satisfied, based on a result of the analysis. The results thereof were as indicated in Table 1. Table 1 lists the kind of the covering source material other than the electrolyte salt serving also as the covering source material, the location where the covering source material was included, and the content (wt %) of the covering source material.

### Evaluation of Battery Characteristic

The secondary batteries were each evaluated for an electric resistance characteristic as the battery characteristic in accordance with the following procedure. The evaluation revealed the results presented in Table 1.

To evaluate the electric resistance characteristic, first, the secondary battery was charged in an ambient temperature environment (at a temperature of 25° C.) with a current of 0.1 C until a voltage reached 4.25 V. Thereafter, the secondary battery in a charged state was subjected to measurements by electrochemical impedance spectroscopy (EIS) with an impedance analyzer (AC Impedance Analyzer 1255WB available from Solartron Analytical) to thereby acquire a Nyquist plot. In this case, a voltage to be applied was set to 10 mV, and a frequency range was set to 100 kHz to 0.1 Hz. Lastly, a charge transfer resistance (a pre-cycle charge transfer resistance (Ω)) of the test electrode 61 was measured based on the Nyquist plot (an arc on a low-frequency side).

Thereafter, the secondary battery was repeatedly charged and discharged in the same environment until the total number of cycles reached 100. Upon charging, the secondary battery was charged with a constant current of 1 C until a voltage reached 4.25 V, and thereafter charged with a constant voltage of 4.25 V until a current reached 0.01 C. Upon discharging, the secondary battery was discharged with a constant current of 5 C until the voltage reached 2.5 V. Note that 1 C was a value of the current that caused the battery capacity to be completely discharged in 1 hour, and 5 C was a value of the current that caused the battery capacity to be completely discharged in 0.2 hours.

Thereafter, the secondary battery was charged in the same environment with a current of 0.1 C until a voltage reached 4.25 V, following which a charge transfer resistance (a post-cycle charge transfer resistance (Ω)) of the test electrode 61 was calculated by the above-described procedure.

Lastly, an increase rate as an index for evaluating the electric resistance characteristic was calculated based on the following calculation expression: increase rate=[(post-cycle charge transfer resistance−pre-cycle charge transfer resistance)/pre-cycle charge transfer resistance]×100. The increase rate was a characteristic value indicating how many times the post-cycle charge transfer resistance was higher than the pre-cycle charge transfer resistance.

TABLE 1

| | Positive electrode active material particle | | | | | | | | | | |
|---|---|---|---|---|---|---|---|---|---|---|---|
| | Center part | | | | | | | Physical properties | | | |
| | | Con- | | | Covering source material | | | First | Second | Third | |
| | | tent | | | | Location where | | physical | physical | physical | |
| | | ratio | Con- | Covering | | covering source | Con- | property | property | property | In- |
| | Lithium composite | C | tent | part | | material was | tent | condi- | condi- | condi- | crease |
| | oxide | (mol %) | (wt %) | Kind | Kind | included | (wt %) | tion | tion | tion | rate |
| Example 1 | LiNi_{0.88}Co_{0.10}Al_{0.02}O₂ | 88 | 1.2 | LiBOF₂ | LiBF₄ | Electrolytic | 0.6 | Satisfied | Satisfied | Satisfied | 12.0 |
| | | | | | | solution | | | | | |
| Example 2 | LiNi_{0.88}Co_{0.10}Al_{0.02}O₂ | 88 | 0.7 | LiBOF₂ | LiBF₄ | Electrolytic | 0.6 | Satisfied | Satisfied | Satisfied | 40.7 |
| | | | | | | solution | | | | | |
| Example 3 | LiNi_{0.86}Co_{0.10}Al_{0.04}O₂ | 86 | 1.1 | LiBOF₂ | LiBF₄ | Electrolytic | 0.6 | Satisfied | Satisfied | Satisfied | 22.3 |
| | | | | | | solution | | | | | |
| Example 4 | LiNi_{0.86}Co_{0.10}Al_{0.04}O₂ | 86 | 0.6 | LiBOF₂ | LiBO₂ | Test electrode | 0.5 | Satisfied | Satisfied | Satisfied | 55.2 |
| Comparative | LiNi_{0.88}Co_{0.10}Al_{0.02}O₂ | 88 | 0.1 | LiBOF₂ | LiBF₄ | Electrolytic | 0.6 | Satisfied | Satisfied | Not | 434.0 |
| Example 1 | | | | | | solution | | | | satisfied | |
| Comparative | LiNi_{0.88}Co_{0.10}Al_{0.02}O₂ | 88 | 0.5 | LiBOF₂ | LiBF₄ | Electrolytic | 0.2 | Satisfied | Satisfied | Not | 410.0 |
| Example 2 | | | | | | solution | | | | satisfied | |
| Comparative | LiNi_{0.88}Co_{0.10}Al_{0.02}O₂ | 88 | 1.2 | — | — | — | — | Satisfied | Satisfied | Not | 472.5 |
| Example 3 | | | | | | | | | | satisfied | |

As indicated in Table 1, when the lithium composite oxide (content ratio C≥80 mol %) was used as the material included in the center part, the increase rate greatly varied depending on the physical properties of the positive electrode active material layer.

Specifically, even when the covering part was formed using the covering source material, the increase rate markedly increased in a case where, although the first and second physical property conditions were satisfied, the third physical property condition was not satisfied due to insufficiency of the amount of formation of the covering part (Comparative examples 1 and 2).

Similarly, the increase rate also increased markedly when no covering part was formed due to the use of no covering source material and therefore the third physical property condition was not satisfied although the first and second physical property conditions were satisfied (Comparative example 3).

In contrast, the increase rate markedly decreased when not only the first and second physical property conditions but also the third physical property condition was satisfied because the covering part was formed using the covering source material and the amount of formation of the covering part was sufficient (Comparative examples 1 to 4).

In this case, the following tendencies were obtained, in particular. Firstly, the increase rate sufficiently decreased even when the content ratio C was changed. Secondly, the increase rate sufficiently decreased even when the composition of the lithium composite oxide (the kind of the other element) was changed. Thirdly, the increase rate markedly decreased when the covering part included lithium fluoroborate.

The results presented in Table 1 indicate that when: the positive electrode active material layer included the positive electrode active material particles; the positive electrode active material particles each included the center part and the covering part; the center part included the lithium composite oxide (content ratio C≥80 mol %); and the three physical property conditions were satisfied regarding the result of analysis of the positive electrode active material layer 21B in the depth direction D by the TOF-SIMS, the increase rate decreased. The electric resistance characteristic thus improved. Accordingly, the secondary battery achieved a superior battery characteristic.

Although the present technology has been described herein with reference to one or more embodiments including Examples, the configuration of the present technology is not limited thereto, and is therefore modifiable in a variety of ways.

For example, the description has been given of the case where the secondary battery has a battery structure of the laminated-film type or the coin type. However, the battery structure of the secondary battery is not particularly limited, and the secondary battery may thus have a battery structure of, for example, a cylindrical type, a prismatic type, or a button type.

Further, the description has been given of the case where the battery device has a device structure of a wound type; however, the device structure of the battery device is not particularly limited, and the battery device may thus have a device structure of, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited thereto. Accordingly, the present technology may achieve other effects.

Note that the present technology may have any of the following configurations according to an embodiment.

<1>

A secondary battery including:
a positive electrode including a positive electrode active material layer;
a negative electrode; and
an electrolytic solution, in which
the positive electrode active material layer includes positive electrode active material particles,
the positive electrode active material particles each include
   a center part including a lithium composite oxide, and
   a covering part provided on a surface of the center part,
the lithium composite oxide has a layered rock-salt crystal structure, and includes lithium, nickel, and another element as constituent elements,
where a sum of a content of nickel in the lithium composite oxide and a content of the other element in the lithium composite oxide is taken as 100 parts by mole, the content of nickel in the lithium composite oxide is greater than or equal to 80 parts by mole and less than or equal to 100 parts by mole,
based on an analysis of the positive electrode active material layer in a depth direction by time-of-flight secondary ion mass spectrometry, a first negative secondary ion derived from NiO₂⁻ and a second negative secondary ion derived from LiBO₂F⁻ are detectable, and a first depth profile and a second depth profile are acquirable, the first depth profile indicating a change in ionic strength of the first negative secondary ion in the depth direction, the second depth profile indicating a change in ionic strength of the second negative secondary ion in the depth direction,
in the first depth profile, the ionic strength of the first negative secondary ion increases in the depth direction,
in the second depth profile, the ionic strength of the second negative secondary ion decreases in the depth direction, and
the second depth profile includes a stepped region in which the ionic strength of the second negative secondary ion temporarily stops decreasing in the depth direction midway through an increase in the ionic strength of the first negative secondary ion in the depth direction.
   <2>

The secondary battery according to <1>, in which the covering part includes lithium, boron, and fluorine as constituent elements.

<3>

The secondary battery according to <2>, in which the covering part includes lithium fluoroborate (LiBOF₂).

<4>

The secondary battery according to any one of <1> to <3>, in which the other element includes at least one other element that includes at least one of cobalt, aluminum, manganese, zirconium, titanium, molybdenum, tantalum, chromium, niobium, iron, copper, zinc, vanadium, magnesium, tungsten, sulfur, strontium, boron, sodium, or fluorine.

<5>

The secondary battery according to any one of <1> to <4>, in which the secondary battery includes a lithium-ion secondary battery.

### DESCRIPTION OF REFERENCE NUMERALS

| | |
|---|---|
| 21 | positive electrode |
| 21B | positive electrode active material layer |
| 22 | negative electrode |
| 210 | positive electrode active material particle |
| 210X | center part |
| 210Y | covering part |

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution, wherein
the positive electrode active material layer includes positive electrode active material particles,
the positive electrode active material particles each include
a center part including a lithium composite oxide, and
a covering part provided on a surface of the center part,
the lithium composite oxide has a layered rock-salt crystal structure, and includes lithium, nickel, and another element as constituent elements,
where a sum of a content of nickel in the lithium composite oxide and a content of the other element in the lithium composite oxide is taken as 100 parts by mole, the content of nickel in the lithium composite oxide is greater than or equal to 80 parts by mole and less than or equal to 100 parts by mole,
based on an analysis of the positive electrode active material layer in a depth direction by time-of-flight secondary ion mass spectrometry, a first negative secondary ion derived from NiO₂⁻ and a second negative secondary ion derived from LiBO₂F⁻ are detectable, and a first depth profile and a second depth profile are acquirable, the first depth profile indicating a change in ionic strength of the first negative secondary ion in the depth direction, the second depth profile indicating a change in ionic strength of the second negative secondary ion in the depth direction,
in the first depth profile, the ionic strength of the first negative secondary ion increases in the depth direction,
in the second depth profile, the ionic strength of the second negative secondary ion decreases in the depth direction, and
the second depth profile includes a stepped region in which the ionic strength of the second negative secondary ion temporarily stops decreasing in the depth direction midway through an increase in the ionic strength of the first negative secondary ion in the depth direction.

2. The secondary battery according to claim 1, wherein the covering part includes lithium, boron, and fluorine as constituent elements.

3. The secondary battery according to claim 2, wherein the covering part includes lithium fluoroborate (LiBOF₂).

4. The secondary battery according to claim 1, wherein the other element comprises at least one other element that includes at least one of cobalt, aluminum, manganese, zirconium, titanium, molybdenum, tantalum, chromium, niobium, iron, copper, zinc, vanadium, magnesium, tungsten, sulfur, strontium, boron, sodium, or fluorine.

5. The secondary battery according to claim 1, wherein the secondary battery comprises a lithium-ion secondary battery.
